(19) United States
(12) Patent Application Publication
(10) Pub. No.: US 2014/0085331 A1
(43) Pub. Date: Mar. 27, 2014

(54) APPARATUS, METHOD, AND PROGRAM PRODUCT FOR SELECTING A FINISH

(71) Applicant: Harris Research, Inc., Logan, UT (US)

(72) Inventors: Benjamin N. Davis, Providence, UT (US); Adam C. Kirschman, Logan, UT (US)

(73) Assignee: Harris Research, Inc., Logan, UT (US)

(21) Appl. No.: 14/030,943

(22) Filed: Sep. 18, 2013

Related U.S. Application Data
(60) Provisional application No. 61/702,607, filed on Sep. 18, 2012.

(51) Int. Cl. G09G 5/377

(52) U.S. Cl. CPC G09G 5/377
USPC 345/629

(57) ABSTRACT

An apparatus, method, and program product for selecting at least a portion of an image, the selected portion comprising a surface of an item within the image, displaying a semi-transparent overlay over the selected portion of the image, the semi-transparent overlay representing a surface finish, and mathematically blending a plurality of pixels of the semi-transparent overlay with a plurality of pixels of the selected portion such that one or more characteristics of the surface are visible through the semi-transparent overlay.

### CROSS-REFERENCES TO RELATED APPLICATIONS

This application claims the benefit of U.S. Provisional Patent Application No. 61/702,607 entitled “APPARATUS, SYSTEM, AND METHOD FOR SELECTING A FINISH” and filed on Sep. 18, 2012, for Benjamin N. Davis et al., which is incorporated herein by reference.

### BACKGROUND

1. Field

The subject matter disclosed herein relates to image processing and more particularly relates to selecting a virtual finish for a digital image of a surface.

2. Description of the Related Art

Traditionally, finding an appropriate finish for a surface required going to the store and choosing various samples of colors, stains, etc., taking them home, and holding the samples against the surface to determine if the finish is appropriate. With the advent of smart phones and other handheld electronic devices, a user can capture a picture of a surface and employ different image processing techniques to apply various virtual finish overlays to an image of a surface.

The problem, however, is that the finish overlays may not blend well with the underlying surface, which obscures details of the surface. For example, wood grain patterns may not be visibly apparent through the overlay. This may not provide a natural-looking or realistic representation of what the finish would naturally look like if applied to the surface.

### BRIEF SUMMARY

From the foregoing discussion, it should be apparent that a need exists for an apparatus, method, and computer program product for selecting a surface finish. Beneficially, such an apparatus, method, and computer program product would blend the pixels of a finish overlay with an underlying image of a surface such that details and characteristics of the surface are visible through the overlay.

The subject matter of the present application has been developed in response to the present state of the art, and in particular, in response to the problems and needs in the art that have not yet been fully solved by currently available finish selection methods. Accordingly, the present disclosure has been developed to provide a flexible book binding with interchangeable pages that overcomes many or all of the above-discussed shortcomings in the art.

In one embodiment, an apparatus to select a surface finish is provided that includes a polygon selection module configured to select at least a portion of an image. In another embodiment, the selected portion includes a surface of an item within the image. In certain embodiments, the apparatus includes an overlay module configured to display a semi-transparent overlay over the selected portion of the image. In some embodiments, the semi-transparent overlay represents a surface finish. In a further embodiment, the apparatus includes a blending module configured to mathematically blend a plurality of pixels of the semi-transparent overlay with a plurality of pixels of the selected portion of the image such that one or more characteristics of the surface are visible through the semi-transparent overlay.

In another embodiment, the surface comprises a wood surface and the one or more characteristics of the wood surface includes one or more of a grain pattern, a brightness, a contrast, and a shading. In another embodiment, the apparatus includes an adjustment module configured to adjust one or more characteristics of the semi-transparent overlay. In some embodiments, the pixels of the semi-transparent overlay and the pixels of the selected portion are mathematically reblended in response to the adjustment. In one embodiment, the one or more characteristics of the semi-transparent overlay includes one or more of an opacity, color, gradient, and shading.

In certain embodiments, the apparatus includes a storage module configured to combine the image and the semi-transparent overlay into a combined image and stores a copy of the combined image on a computer readable storage medium. In another embodiment, the apparatus includes a distribution module configured to distribute a copy of the combined image. In certain embodiments, the combined image is distributed using one or more of an email, a text message, and a website. In a further embodiment, the apparatus includes a social module configured to share the combined image on a social media network.

In one embodiment, a method to select a surface finish is provided. In one embodiment, the method includes selecting at least a portion of an image. In another embodiment, the selected portion includes a surface of an item within the image. In certain embodiments, the method includes displaying a semi-transparent overlay over the selected portion of the image. In some embodiments, the semi-transparent overlay represents a surface finish. In a further embodiment, the method includes mathematically blending a plurality of pixels of the semi-transparent overlay with a plurality of pixels of the selected portion of the image such that one or more characteristics of the surface are visible through the semi-transparent overlay.

In another embodiment, the surface comprises a wood surface and the one or more characteristics of the wood surface includes one or more of a grain pattern, a brightness, a contrast, and a shading. In another embodiment, the method includes adjusting one or more characteristics of the semi-transparent overlay. In some embodiments, the pixels of the semi-transparent overlay and the pixels of the selected portion are mathematically reblended in response to the adjustment. In one embodiment, the one or more characteristics of the semi-transparent overlay includes one or more of an opacity, color, gradient, and shading.

In certain embodiments, the method includes combining the image and the semi-transparent overlay into a combined image and storing a copy of the combined image on a computer readable storage medium. In another embodiment, the method includes distributing a copy of the combined image. In certain embodiments, the combined image is distributed using one or more of an email, a text message, and a website. In a further embodiment, the apparatus includes sharing the combined image on a social media network.

In one embodiment, a program product is provided including computer readable storage medium storing machine readable code executable by a processor to perform the operations. In one embodiment, the operations include selecting at least a portion of an image. In another embodiment, the selected portion includes a surface of an item within the image. In certain embodiments, the operations include displaying a semi-transparent overlay over the selected portion of the image. In some embodiments, the semi-transparent overlay represents a surface finish. In a further embodiment, the operations include mathematically blending a plurality of pixels of the semi-transparent overlay with a plurality of pixels of the selected portion of the image such that one or more characteristics of the surface are visible through the semi-transparent overlay. In one embodiment, the operations include adjusting one or more characteristics of the semi-transparent overlay, the pixels of the semi-transparent overlay and the pixels of the selected portion being mathematically reblended in response to the adjustment.

In another embodiment, the surface comprises a wood surface and the one or more characteristics of the wood surface includes one or more of a grain pattern, a brightness, a contrast, and a shading. In another embodiment, the operations include combining the image and the semi-transparent overlay into a combined image and storing a copy of the combined image on a computer readable storage medium. In yet another embodiment, the operations include distributing a copy of the combined image. In certain embodiments, the combined image is distributed using one or more of an email, a text message, a website, and a social media network.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for selecting a finish in accordance with the subject matter disclosed herein;

FIG. 2 is a schematic block diagram illustrating one embodiment of an apparatus for selecting a finish in accordance with the subject matter disclosed herein;

FIG. 3 is a schematic block diagram illustrating another embodiment of an apparatus for selecting a finish in accordance with the subject matter disclosed herein;

FIG. 4 illustrates one embodiment of a system for selecting a finish in accordance with the subject matter disclosed herein;

FIG. 5 illustrates another embodiment of a system for selecting a finish in accordance with the subject matter disclosed herein;

FIG. 6 illustrates yet another embodiment of a system for selecting a finish in accordance with the subject matter disclosed herein; and

FIG. 7 is a schematic flow chart diagram illustrating one embodiment of a method for selecting a finish in accordance with the subject matter disclosed herein.

### DETAILED DESCRIPTION

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

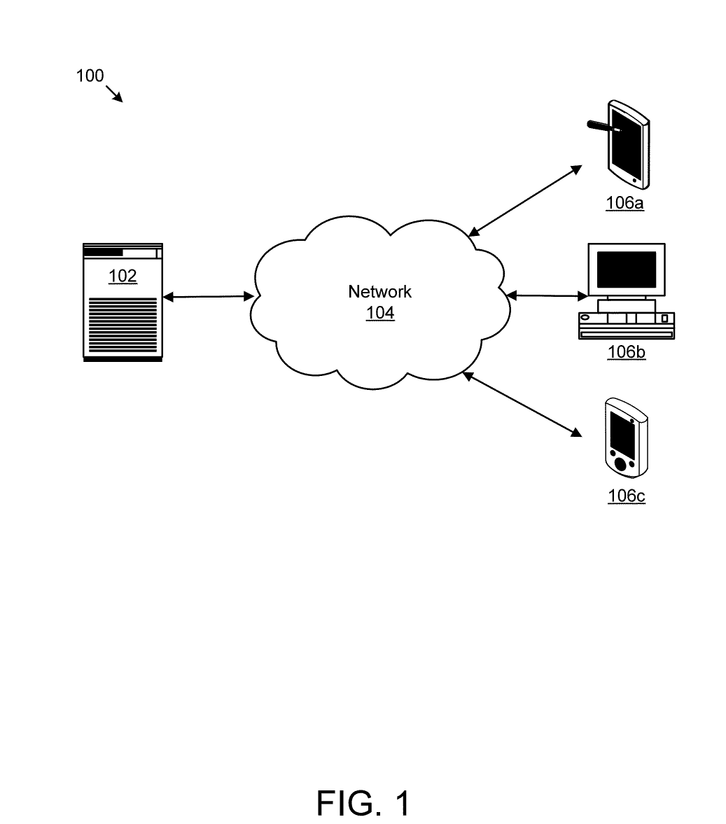

FIG. 1 is a schematic block diagram illustrating one embodiment of a system 100 for selecting a finish. In the depicted embodiment, the system 100 includes a server 102, a network 104, and a plurality of client devices 106. As used herein, the server 102 may also be configured as a mainframe computer, a blade center comprising multiple blades, a desktop computer, and the like. Although for simplicity one server 102, one network 104, and three clients 106 are shown, any number of servers 102, networks 104, and clients 106 may be employed. One of skill in the art will also readily recognize that the system 100 could include other devices such as routers, printers, scanners, and the like.

The server 102, in one embodiment, includes memory storing computer readable programs and includes a processor executing the computer readable programs as is well known to those skilled in the art. The computer readable programs may be tangibly stored in storage in communication with the server 102. The server 102 may be configured as an e-mail server, social media server, multimedia server, and/or the like. In certain embodiments, the server 102 performs at least a portion of the operations associated with the finish selection apparatus 200 described below. In some embodiments, the server 102 stores data in a data store, such as a database, which is accessed by a client 106 through the network 104. The data may include digital images, digital overlays, and/or the like.

In another embodiment, the system 100 includes a data network 104. The data network 104, in certain embodiments, is a digital communication network 104 that transmits digital communications related to selecting a finish. The digital communication network 104 may include a wireless network, such as a wireless telephone network, a local wireless network, such as a Wi-Fi network, a Bluetooth® network, and the like. The digital communication network 104 may include a wide area network (“WAN”), a storage area network (“SAN”), a local area network (“LAN”), an optical fiber network, the internet, or other digital communication network known in the art. The digital communication network 104 may include two or more networks. The digital communication network 104 may include one or more servers, routers, switches, and/or other networking equipment. The digital communication network 104 may also include computer readable storage media, such as a hard disk drive, an optical drive, non-volatile memory, random access memory (“RAM”), or the like.

Each client 106 may be embodied as a desktop computer, a portable computer, a server, a mainframe computer, a handheld computing device, a touch device, a personal desktop assistant (“PDA”), a tablet computer, an eBook reader, a mobile phone, a smart phone, a smart TV, or the like. In certain embodiments, the client device 106 includes a digital camera (not shown) configured to capture digital images. Each client 106 may communicate with the server 102 through the network 104. In one embodiment, a client 106 communicates with the server 102 by way of a program executing on the client 106, such as an application configured to access and/or download content from the server 102, as is known in the art. In one embodiment, the server 102 may distribute one or more digital images, which may be accessible to the client devices 106 over the network 104. In certain embodiments, the program on the client device 106 allows a user to store digital images from the client device 106 on the server 102. In one embodiment, a user interacts with the client device 106 using an input device, which may include a finger, mouse, stylus, joystick, controller, and the like. One of skill in the art will recognize other ways for a user to interact with a client device 106.

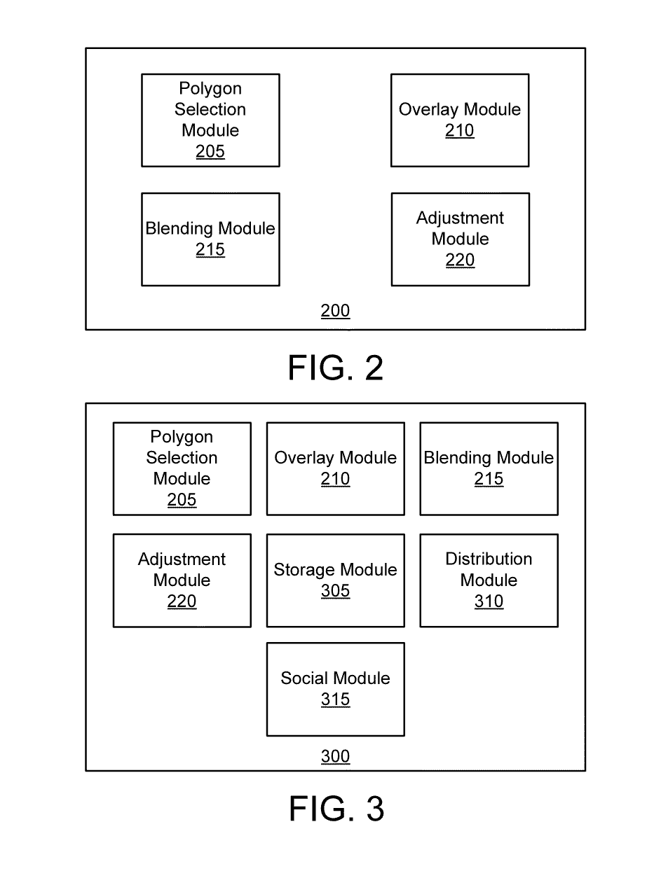

FIG. 2 depicts one embodiment of a finish selection apparatus 200. The finish selection apparatus 200, in one embodiment, manages the selection and customization of at least a portion of a digital image. In the depicted embodiment, the finish selection apparatus 200 includes a polygon selection module 205, an overlay module 210, a blending module 215, and an adjustment module 220, which are described in more detail below.

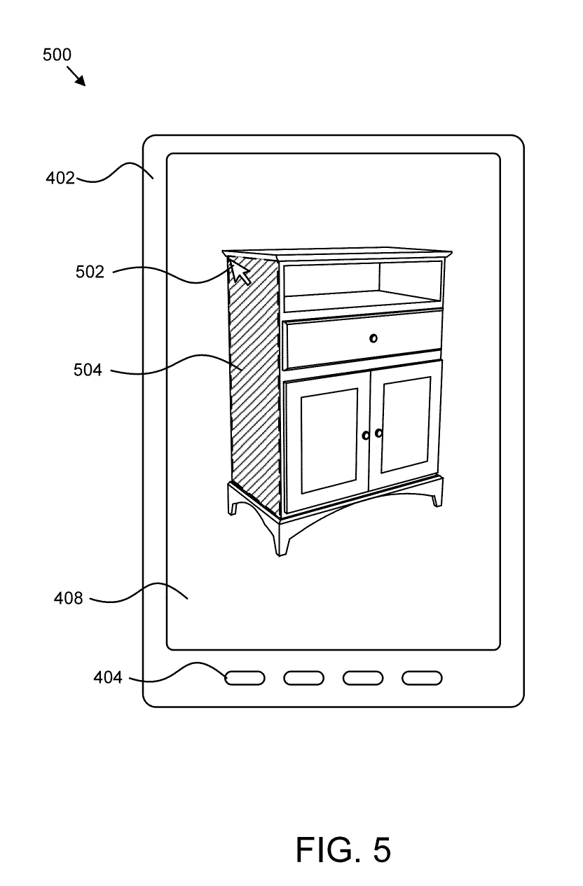

The apparatus 200, in one embodiment, includes a polygon selection module 205 configured to select at least a portion of a digital image, as described in greater detail with reference to FIG. 5. In certain embodiments, the selected portion includes a surface of an item within the image. For example, the polygon selection module 205 may select a surface of a cabinet, such as a cabinet door. In one embodiment, the digital image is stored on the client device 106 or on a server 102 and downloaded by an application on the client device 106 through the network 104. The polygon selection module 205 selects a portion of a digital image for customization. In one embodiment, the polygon selection module 205 uses an edge detection algorithm to predict polygonal shapes within the image and detects and corrects edge fragmentation that may occur when edge curves are not connected.

In another embodiment, the apparatus 200 includes an overlay module 210 configured to display a semi-transparent overlay over the selected portion of the image. The overlay, in one embodiment, represents a virtual surface finish that a user may customize in order to determine a potential finish for the surface in the image. The finish, for example, may include a stain, oil, shellac, varnish, paint, resin, and/or the like The semi-transparent overlay may include one or more characteristics, such as an opacity, a color, a gradient, a shading, and/or the like. In certain embodiments, the overlay module 210 adjusts one or more of the overlay characteristics based on input received from a user. For example, a user may specify the opacity and color of the overlay. As describe in more detail below, the pixels of the overlay may be blended with the pixels of the selected portion of the image i.e., the surface, in order to provide a realistic-looking finish. For example, on a wooden surface, the pixels of the overlay may be blended with the pixels of the selected portion of the image such that the natural grain patterns, colors, shading, and/or the like, of the wooden surface are still discernible through the overlay. The user may then customize the overlay to determine a potential finish for the surface that suits their taste.

In one embodiment, the apparatus 200 includes a blending module 215 configured to mathematically blend a plurality of pixels of the semi-transparent overlay with a plurality of pixels of the selected portion of the image such that one or more characteristics of the surface are discernible through the overlay. For example, if the selected polygon of the digital image contains different shades of textures and/or lighting, the blending module 215 may mathematically calculate the darkness of the pixels in the overlay such that dark areas in the original selected polygon will remain dark and light areas will remain light. This allows the original characteristics of the underlying selected portion of the digital image, such as the grain and texture of a wood surface, to show through and not be obscured by the overlay. In certain embodiments, the blending module 215 uses one or more blending algorithms, such as alpha blending, to mathematically blend the pixels of the two images.

In one embodiment, the apparatus 200 includes an adjustment module 220 configured to adjust one or more characteristics of the overlay. In another embodiment, the pixels of the overlay and the pixels of the selected portion are mathematically reblended in response to the adjustment. In some embodiments, characteristics of the overlay includes an opacity, a color, a gradient, a shading, a hue, a contrast, and/or the like. In one embodiment, the user customizes one or more of the characteristics of the overlay. For example, the user may select an overlay color from a plurality of selectable colors, e.g., if the overlay is for a wood surface, the plurality of colors may include different shades of wood stains. Alternatively, the plurality of colors may include interior/exterior paint colors if the overlay is for a surface such as a wall, or flooring colors if the overlay is for a carpet, tile, or hardwood surface. The adjustment module 220, in one embodiment, adjusts the opacity of the overlay such that the colorization is semi-transparent. As the opacity is adjusted, in one embodiment, the blending module 215 mathematically blends the pixels of the underlying selected polygon and the overlay, allowing the natural appearance of the underlying surface to show through the overlay.

FIG. 3 depicts another embodiment of a finish selection apparatus 300. The description of the apparatus 300 refers to elements of FIGS. 1 and 2, like numbers referring to like elements. The depicted apparatus 300 includes a polygon selection module 205, an overlay module 210, a blending module 215, and an adjustment module 220, wherein these modules are substantially similar to the like numbered modules in FIG. 2. Further, the apparatus 300 includes a storage module 305, a distribution module 310, and a social module 315. While the depicted embodiment includes the above listed modules, in certain embodiments, the apparatus 300 includes a subset of the depicted modules alone and/or in various combinations.

In one embodiment, the apparatus 300 includes a storage module 305 configured to combine the image and the semi-transparent overlay into a combined image. The blended digital image, in one embodiment, may be store on a computer readable storage medium located on the client device 106 where the customizations were created. Alternatively, the blended digital image may be saved on a remote server 102, for example, a cloud server, and accessed through a network 104.

In another embodiment, the apparatus 300 includes a distribution module 310 configured to distribute the combined digital image. In one embodiment, the distribution module 310 distributes the combined image to other client devices 106. For example, the distribution module 310 may be configured to distribute the combined digital image by email, text, SMS and/or the like such that the combined digital image may be easily shared with others. In some embodiments, the distribution module 310 posts the combined image on a website. Alternatively, the social module 315, in one embodiment, is configured to post the combined digital image on a social media platform, such as Facebook®, Twitter®, and/or the like, to be shared with others in the user's social media network.

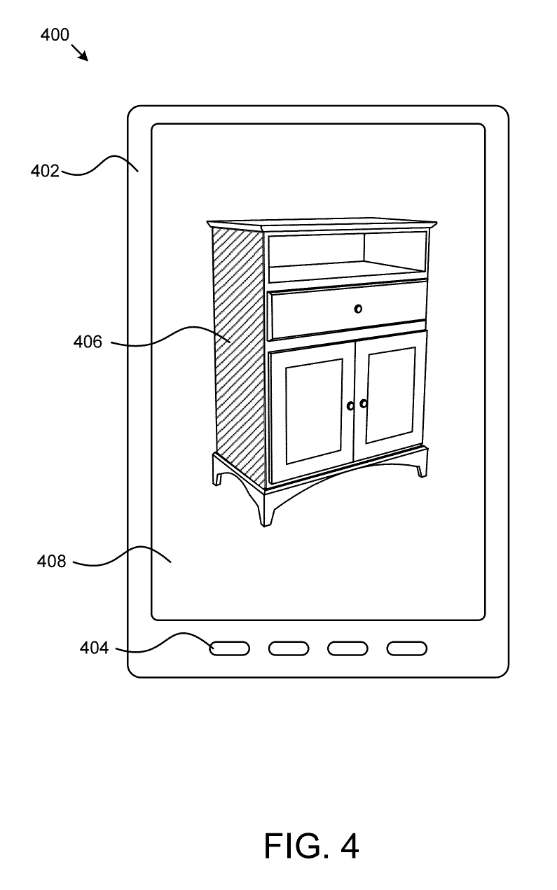

FIG. 4 depicts one embodiment of a system 400 for selecting a surface finish. A client device 402, such as a smart phone or tablet computer with an embedded digital camera (not shown), may be used to take a digital picture of an item, such as a cabinet, a surface of which the user wishes to customize. The client device 402 may have a plurality of physical buttons 404 that a user may use to interact with the client device 402, for example, to take a digital picture. Alternatively, the client device 402, in one embodiment, does not include any physical buttons 404, but instead incorporates a touch screen device that receives input from a user interacting with the touch sensitive display 408 with an input device such as a finger or stylus. In one embodiment, the client device 402 includes both physical buttons 404 and a touch sensitive display 408. The depicted embodiment illustrates an example of a digital picture of an object taken with the client device 402 where one surface has visible areas of texture 406, such as a wooden surface with a grain pattern and areas with different shades of color.

FIG. 5 depicts another embodiment of a system 500 for selecting a surface finish. As shown in FIG. 5, once the client device 402 has loaded the digital image, a polygon selection tool 502 may be used to select at least a portion 504 of the image for customization. The polygon selection tool 502 may be interacted with by using one of a plurality of physical buttons 404 located on the client device 402. Alternatively, the polygon selection tool 502 may be manipulated by making gestures on the touch sensitive display 408 with an input device such as a finger or stylus.

In one embodiment, the polygon selection module 205 provides a “free-hand” selection tool, which allows a user to select a portion of an image in one gesture, without removing the input device from the display. In another embodiment, the polygon selection module 205 allows a user to select a portion of an image using multiple input gestures. A user may create multiple lines and connect the lines to create the polygonal shape, giving the user more control over the customization of the digital image. The polygon selection module 205, in certain embodiments, uses an anti-aliasing algorithm to ensure the selected portion of the digital image contains substantially smooth edges.

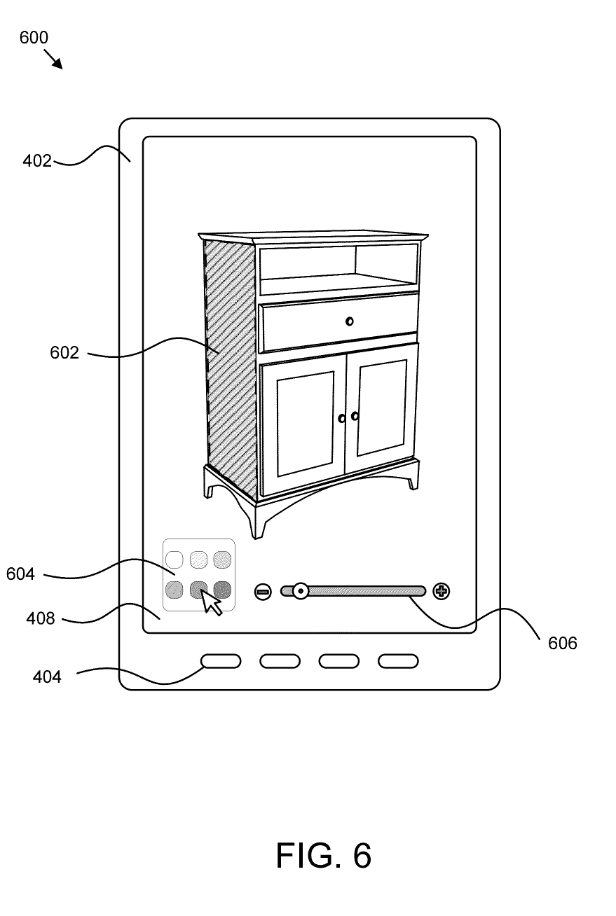

FIG. 6 depicts yet another embodiment of a system 600 for selecting a finish. After the user selects a portion of the digital image using the polygon selection tool, as shown in FIG. 6, the overlay module 210 presents a semi-transparent overlay 602 over the selected portion. The color of the overlay 602, in one embodiment, may be changed using a digital color palette 604 provided by the adjustment module 220. The user may easily switch the color of the overlay 602 by selecting different colors using the digital color palette 604. In one embodiment, the different colors may be selected by using the physical buttons 404, or, alternatively, with an input device on the touch sensitive display 408.

The opacity of the overlay 602 may also be adjusted, in one embodiment, by using an opacity adjustment tool 606, which is shown as a slider tool in the depicted embodiment. In one embodiment, the slider tool may be adjusted by using the physical buttons 404, or, alternatively, with an input device on the touch sensitive display 408. As the opacity is adjusted to make the overlay 602 more or less transparent, the blending module 215 mathematically blends the pixels of the overlay 602 with the pixels of the selected portion of the digital image to ensure the characteristics of the surface, such as texture and lighting, are not obscured. For example, if the selected area is a wood surface with darker areas, as the opacity is increased, the darker areas become darker relative to the rest of the overlay 602. Similarly, if an area of the surface is receiving a lot of light, the light spots are going to be lighter than the rest of the overlay.

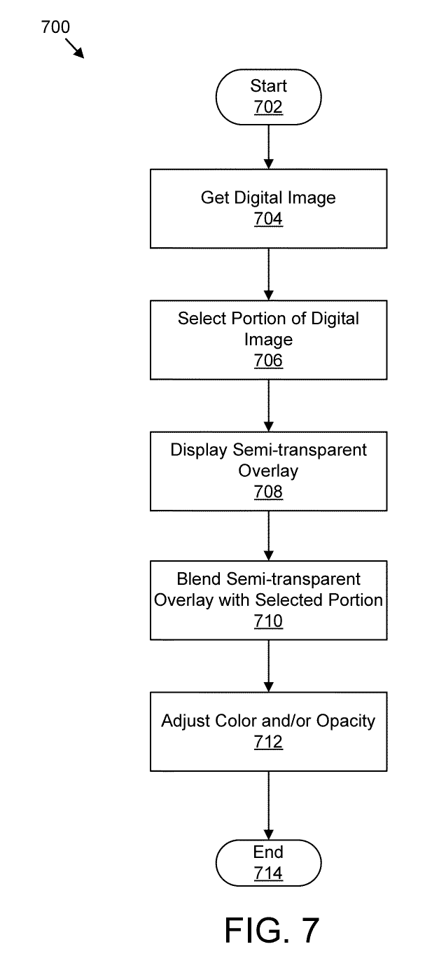

FIG. 7 is a schematic flow chart diagram illustrating one embodiment of a method 700 for selecting a finish. In one embodiment, the method 700 begins 702 and a digital image is displayed 704 on the client device 106. The digital image, in another embodiment, is taken with a digital camera embedded on the client device 106. Alternatively, the digital image may be downloaded from a remote server 102. The polygon selection module 205, in certain embodiments, selects 706 at least a portion of the image to be customized. The overlay module 210, in some embodiments, displays 708 a semi-transparent overlay over the selected portion of the image. In one embodiment, a blending module 215 blends 710 the pixels of the semi-transparent overlay with the pixels of the selected portion of the digital image. The adjustment module 220, in a further embodiment, adjusts 712 the color of the overlay and/or the desired level of opacity and the method 700 ends 714.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to select a surface finish, the apparatus comprising:
a polygon selection module configured to select at least a portion of an image, the selected portion comprising a surface of an item within the image;
an overlay module configured to display a semi-transparent overlay over the selected portion of the image, the semi-transparent overlay representing a surface finish; and
a blending module configured to mathematically blend a plurality of pixels of the semi-transparent overlay with a plurality of pixels of the selected portion of the image such that one or more characteristics of the surface are visible through the semi-transparent overlay.

2. The apparatus of claim 1, wherein the surface comprises a wood surface, the one or more characteristics of the wood surface comprising one or more of a grain pattern, a brightness, a contrast, and a shading.

3. The apparatus of claim 1, further comprising an adjustment module configured to adjust one or more characteristics of the semi-transparent overlay, the pixels of the semi-transparent overlay and the pixels of the selected portion being mathematically reblended in response to the adjustment.

4. The apparatus of claim 3, wherein the one or more characteristics of the semi-transparent overlay comprises one or more of an opacity, color, gradient, and shading.

5. The apparatus of claim 1, further comprising a storage module configured to combine the image and the semi-transparent overlay into a combined image and stores a copy of the combined image on a computer readable storage medium.

6. The apparatus of claim 5, further comprising a distribution module configured to distribute a copy of the combined image.

7. The apparatus of claim 6, wherein the combined image is distributed using one or more of an email, a text message, and a website.

8. The apparatus of claim 5, further comprising a social module configured to share the combined image on a social media network.

9. A method to select a surface finish, the method comprising:
selecting at least a portion of an image, the selected portion comprising a surface of an item within the image;
displaying a semi-transparent overlay over the selected portion of the image, the semi-transparent overlay representing a surface finish; and
mathematically blending a plurality of pixels of the semi-transparent overlay with a plurality of pixels of the selected portion such that one or more characteristics of the surface are visible through the semi-transparent overlay.

10. The method of claim 9, wherein the surface comprises a wood surface, the one or more characteristics of the wood surface comprising one or more of a grain pattern, a brightness, a contrast, and a shading.

11. The method of claim 9, further comprising adjusting one or more characteristics of the semi-transparent overlay, the pixels of the semi-transparent overlay and the pixels of the selected portion being mathematically reblended in response to the adjustment.

12. The method of claim 11, wherein the one or more characteristics of the semi-transparent overlay comprises one or more of an opacity, color, gradient, and shading.

13. The method of claim 9, further comprising combining the image and the semi-transparent overlay into a combined image and storing a copy of the combined image on a computer readable storage medium.

14. The method of claim 13, further comprising distributing a copy of the combined image.

15. The method of claim 14, wherein the combined image is distributed using one or more of an email, a text message, and a website.

16. The method of claim 13, further comprising sharing the combined image on a social media network.

17. A computer program product comprising a computer readable storage medium having computer usable program code executable to perform operations for selecting a surface finish, the operations comprising:
selecting at least a portion of an image, the selected portion comprising a surface of an item within the image;
displaying a semi-transparent overlay over the selected portion of the image, the semi-transparent overlay representing a surface finish;
mathematically blending a plurality of pixels of the semi-transparent overlay with a plurality of pixels of the selected portion such that one or more characteristics of the surface are discernible through the semi-transparent overlay; and
adjusting one or more characteristics of the semi-transparent overlay, the pixels of the semi-transparent overlay and the pixels of the selected portion being mathematically reblended in response to the adjustment.

18. The computer program product of claim 17, wherein the surface comprises a wood surface, the one or more characteristics of the wood surface comprising one or more of a grain pattern, a brightness, a contrast, and a shading.

19. The computer program product of claim 17, further comprising combining the image and the semi-transparent overlay into a combined image and storing a copy of the combined image on a computer readable storage medium.

20. The computer program product of claim 19, further comprising distributing a copy of the combined image, wherein the combined image is distributed using one or more of an email, a text message, a website, and a social media network.
